(19) United States
(12) Patent Application Publication
(10) Pub. No.: US 2018/0294894 A1
(43) Pub. Date: Oct. 11, 2018

(54) DISTORTION CANCELLATION APPARATUS AND DISTORTION CANCELLATION METHOD

(71) Applicant: FUJITSU LIMITED, Kawasaki-shi (JP)

(72) Inventors: Satoshi Matsubara, Kawasaki (JP); Yusuke Tobisu, Yokohama (JP); Kohei Ohta, Kawasaki (JP)

(73) Assignee: FUJITSU LIMITED, Kawasaki-shi (JP)

(21) Appl. No.: 15/898,104

(22) Filed: Feb. 15, 2018

(30) Foreign Application Priority Data
Apr. 11, 2017 (JP) 2017-078457

(51) Int. Cl. H04B 15/00; H04B 17/345

(52) U.S. Cl. CPC H04B 15/00; H04B 17/345

(57) ABSTRACT

There is provided a distortion cancellation apparatus including a memory, and a processor coupled to the memory and the processor configured to acquire a plurality of transmission signals to be wirelessly transmitted at different frequencies, acquire a first plurality of reception signals to which an intermodulation signal generated due to the plurality of transmission signals wirelessly transmitted is added, multiplex at least one set of transmission signals among the plurality of transmission signals to be wirelessly transmitted so as to generate at least one multiplexed transmission signal, generate a cancellation signal for canceling the intermodulation signal, based on the at least one multiplexed transmission signal and the first plurality of reception signals, and cancel the intermodulation signal added to the first plurality of reception signals, based on the cancellation signal.

### CROSS-REFERENCE TO RELATED APPLICATION

This application is based upon and claims the benefit of priority of the prior Japanese Patent Application No. 2017-078457, filed on Apr. 11, 2017, the entire contents of which are incorporated herein by reference.

### FIELD

The embodiments discussed herein are related to a distortion cancellation apparatus and a distortion cancellation method.

### BACKGROUND

In recent years, technologies such as carrier aggregation and multi-input multi-output (MIMO) have been introduced for the purpose of improving throughput in a wireless communication system. The carrier aggregation is a technology in which a base station apparatus and a wireless terminal apparatus communicate with each other using a plurality of carriers having different frequencies. MIMO is a technology in which a transmitting side transmits different data from a plurality of transmission antennas, respectively, and a receiving side demultiplexes a combined wave to which data transmitted from the respective transmission antennas are combined, based on reception signals in a plurality of reception antennas.

With the introduction of these technologies, various signals having different frequencies are transmitted to and from wireless communication apparatuses, such as the base station apparatus and the wireless terminal apparatus. Then, when a source of distortion such as a metal is present on a transmission path for these signals, an intermodulation signal is generated due to the intermodulation among the signals having different frequencies. That is, an intermodulation signal having a frequency of the sum or difference among multiples of a frequency of each of the signals is generated in the source of distortion. Then, in a case where the frequency of the intermodulation signal is included in a reception frequency band of the wireless communication apparatus, the demodulation and decoding of the reception signals are disturbed by the intermodulation signal, and thus, the reception quality is degraded.

In order to suppress the reception quality from being degraded due to the intermodulation signal, for example, it is reviewed to approximately reproduce the intermodulation signal that results from intermodulation between a transmission signal which is transmitted from a wireless communication apparatus and an interference signal that is transmitted from another wireless communication apparatus, and cancel the intermodulation signal that is included in the reception signal.

The intermodulation signal that is generated from the plurality of signals having different frequencies may be reproduced by a computation. For example, it is assumed that the frequency bandwidth of long term evolution (LTE) is 10 MHz, and center frequencies of the transmission signals are f1=1935 [MHz] and f2=1975 [MHz]. In this case, a third-order intermodulation distortion occurs in the frequency bands of 1935 MHz, 1975 MHz, 2015 MHz, 1895 MHz, 1935 MHz, and 1975 MHz.

These are values that are calculated from the following computation equations.

1935 [MHz]=f1*f1*conj(f1)

1975 [MHz]=f1*f2*conj(f1)

2015 [MHz]=f2*f2*conj(f1)

1895 [MHz]=f1*f1*conj(f2)

1935 [MHz]=f1*f2*conj(f2)

1975 [MHz]=f2*f2*conj(f2)

That is, when it is assumed that a center frequency of a reception signal Rx1 is 1895 [MHz], the third-order intermodulation distortion, f1*f1*conj(f2), overlaps with the reception band, and this causes passive intermodulation (PIM).

At this point, in a case where the frequency bandwidth of LTE is 10 MHz, the bandwidth of the third-order intermodulation distortion is 30 MHz, and the PIM occurs in a band of 1880 MHz to 1910 MHz. Because the reception frequency band of the reception signal Rx1 ranges from 1880 MHz to 1890 MHz, the PIM occurs in an entire band of the reception signal Rx1.

Generally, in LTE, because a signal of a bandwidth corresponding to each transmission frequency band is used, one carrier is present for a certain transmission frequency band. For this reason, in LTE, as illustrated in FIG. 16, the third-order intermodulation distortion, f1*f1*conj(f2), may be canceled as a third-order intermodulation distortion, for the reception signal Rx1.

In this manner, in LTE, in a case where the third-order intermodulation distortion is generated from the transmission signals of the two carriers, one circuit that generates the third-order intermodulation distortion may be sufficient.

Related technologies are disclosed in, for example, Japanese National Publication of International Patent Application No. 2009-526442.

### SUMMARY

According to an aspect of the invention, a distortion cancellation apparatus includes a memory, and a processor coupled to the memory and the processor configured to acquire a plurality of transmission signals to be wirelessly transmitted at different frequencies, acquire a first plurality of reception signals to which an intermodulation signal generated due to the plurality of transmission signals wirelessly transmitted is added, multiplex at least one set of transmission signals among the plurality of transmission signals to be wirelessly transmitted so as to generate at least one multiplexed transmission signal, generate a cancellation signal for canceling the intermodulation signal, based on the at least one multiplexed transmission signal and the first plurality of reception signals, and cancel the intermodulation signal added to the first plurality of reception signals, based on the cancellation signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a wireless communication system according to a first embodiment;

FIG. 2 is a diagram illustrating a specific example of the number of coefficients in a cancellation equation;

FIG. 3 a block diagram illustrating an example of a function (a basic configuration) of a processor of a cancellation apparatus;

FIG. 4 is an explanatory diagram illustrating an example of a third-order intermodulation distortion that is a cancellation target for a reception signal in the wireless communication system according to the first embodiment;

FIG. 5 is a block diagram illustrating an example of the function of the processor of the cancellation apparatus in the wireless communication system according to the first embodiment;

FIG. 6 is a block diagram illustrating an example of a configuration of a transmission signal multiplexing unit of the cancellation apparatus in the wireless communication system according to the first embodiment;

FIG. 7 is a flowchart illustrating an example of distortion cancellation processing by the cancellation apparatus in the wireless communication system according to the first embodiment;

FIG. 8 is an explanatory diagram illustrating an example of a third-order intermodulation distortion that is a cancellation target for a reception signal in a wireless communication system according to a second embodiment;

FIG. 9 is a block diagram illustrating an example of a function of a processor of a cancellation apparatus in the wireless communication system according to the second embodiment;

FIG. 10 is a block diagram illustrating an example of a configuration of a reception signal multiplexing unit of the cancellation apparatus in the wireless communication system according to the second embodiment;

FIG. 11 is a block diagram illustrating an example of a configuration of a reception signal demultiplexing unit of the cancellation apparatus in the wireless communication system according to the second embodiment;

FIG. 12 is a flowchart illustrating an example of distortion cancellation processing by the cancellation apparatus in the wireless communication system according to the second embodiment;

FIG. 13 is an explanatory diagram illustrating an example of a third-order intermodulation distortion that is a cancellation target for a reception signal in a wireless communication system according to a third embodiment;

FIG. 14 is a block diagram illustrating an example of a function of a processor of the cancellation apparatus in the wireless communication system according to the third embodiment;

FIG. 15 is a flowchart illustrating an example of distortion cancellation processing by the cancellation apparatus in the wireless communication system according to the third embodiment;

FIG. 16 is an explanatory diagram illustrating an example of a third-order intermodulation distortion that is a cancellation target for a reception signal in LTE; and

FIG. 17 is an explanatory diagram illustrating an example of a third-order intermodulation distortion that is a cancellation target for a reception signal in W-CDMA.

### DESCRIPTION OF EMBODIMENTS

In wideband code division multiple access (W-CDMA), a bandwidth is determined on a per-carrier basis, and in a case where a plurality of carriers are present for each transmission frequency band, the types of third-order intermodulation distortions increase dramatically.

For example, it is assumed that the signal is W-CDMA, and center frequencies of transmission signals are f11=1932.5 [MHz], f12=1937.5 [MHz], f21=1972.5 [MHz], and f22=1977.5 [MHz]. A reception frequency band of a reception signal Rx1 ranges from 1890 MHz to 1895 MHz, and a reception frequency band of a reception signal Rx2 ranges from 1895 MHz to 1900 MHz. In this case, as illustrated in FIG. 17, in W-CDMA, five three-order intermodulation distortions are canceled for each of the reception signals Rx1 and Rx2.

For example, three-order intermodulation distortions, f11*f11*conj(f21) and f11*f12*conj(f21), are canceled for the reception signal Rx1. Furthermore, three-order intermodulation distortions, f11*f11*conj(f22), f11*f12*conj(f22), and f12*f12*conj(f22), are canceled for the reception signal Rx1.

For example, third-order intermodulation distortions, f11*f11*conj(f21), f11*f12*conj(f21), and f12*f12*conj(f21), are canceled for the reception signal Rx2. Furthermore, third-order intermodulation distortions, f11*f12*conj(f22) and f12*f12*conj(f22), are canceled for the reception signal Rx2.

In this manner, in W-CDMA, in a case where third-order intermodulation distortions are generated from the transmission signals of the four carriers, the total number of circuits that generate the third-order intermodulation distortions is 10.

A cancellation signal is used to cancel the intermodulation signal such as the third-order intermodulation distortion. The cancellation signal is a replica of the intermodulation signal that is generated due to a plurality of transmission signals. As described above, the intermodulation signal may be reproduced by a computation. However, because many coefficients are included in a computation equation for calculating the intermodulation signal, a processing load for calculating the intermodulation signal may be large, and thus, the circuit scale of an apparatus may increase.

For example, the intermodulation signal includes odd-order intermodulation distortions, such as a third-order intermodulation distortion and a fifth-order intermodulation distortion, or even-order intermodulation distortions, such as a second-order intermodulation distortion and a fourth-order intermodulation distortion. Particularly, in most cases, the odd-order intermodulation distortions, such as the third-order intermodulation distortion and the fifth-order intermodulation distortion, are included in the intermodulation signal that is included in the reception frequency band. Then, because as the intermodulation distortion becomes in a higher order, more coefficients are included in the computation equation that is used for calculation, a throughput increases in a case where the intermodulation signal is calculated considering a high-order intermodulation distortion. For this reason, a significant amount of computation processing is needed to produce a replica of an effective intermodulation signal, taking into consideration an actual communication situation in a wireless communication system. Therefore, the processing load for calculating the intermodulation signal is large, and the circuit scale of the apparatus increases. This is because as the number of carriers increases, the circuit scale of the apparatus increases exponentially.

Embodiments of a distortion cancellation apparatus and a distortion cancellation method according to the present disclosure will be described in detail below with reference to the drawings. Also, it is noted that the present disclosure is not limited by the following embodiments.

### First Embodiment

Configuration of Wireless Communication System

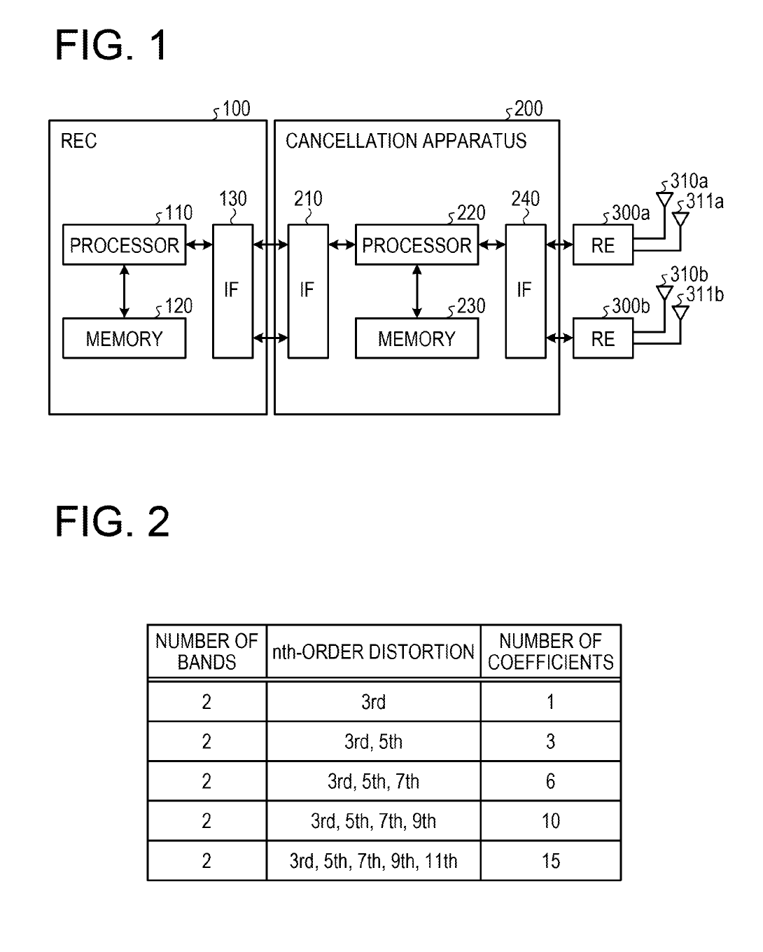

FIG. 1 is a block diagram illustrating an example of a configuration of a wireless communication system according to a first embodiment. The wireless communication system according to the first embodiment includes a Radio Equipment Control (REC) 100, a cancellation apparatus 200, a radio equipment (RE) 300a, and a radio equipment (RE) 300b. FIG. 1 illustrates two REs 300a and 300b, but one RE or three or more REs may be connected to the cancellation apparatus 200. Furthermore, one REC is illustrated, but two or more RECs may be connected to the cancellation apparatus 200.

The REC 100 performs a baseband processing, and transmits a baseband signal including transmission data to the cancellation apparatus 200. Furthermore, the REC 100 receives a baseband signal including reception data from the cancellation apparatus 200, and performs the baseband processing on the baseband signal. Specifically, the REC 100 includes a processor 110, a memory 120, and an interface (IF) 130.

The processor 110 includes, for example, a central processing unit (CPU), a field programmable gate array (FPGA), or a digital signal processor (DSP), and generates a transmission signal that is transmitted from each of the REs 300a and 300b. In the present embodiment, descriptions will be made with an example where the RE 300a transmits transmission signals at different frequencies f1 and f2 from two antennas 310a and 310b, respectively, and the RE 300b transmits transmission signals at different frequencies f3 and f4 from two antennas 310b and 311b, respectively. Thus, the processor 110 generates transmission signals Tx1 and Tx2 that are transmitted from the two antennas 310a and 311a of the RE 300a, respectively, and transmission signals Tx3 and Tx4 that are transmitted from the two antennas 310b and 311b of the RE 300b, respectively. Furthermore, the processor 110 obtains reception data from the reception signals that are received by the REs 300a and 300b.

The memory 120 includes, for example, a random access memory (RAM) or a read only memory (ROM), and stores information which is used by the processor 110 to perform processing.

The interface 130 is connected to the cancellation apparatus 200 through, for example, an optical fiber, and transmits and receives a baseband signal between the interface 130 itself and the cancellation apparatus 200. The baseband signal that is transmitted by the interface 130 includes the transmission signals Tx1, Tx2, Tx3, and Tx4 described above.

The cancellation apparatus 200 is connected between the REC 100 and the REs 300a and 300b, and relays the baseband signal that is transmitted and received between the REC 100 and the REs 300a and 300b. Furthermore, based on the transmission signals Tx1, Tx2, Tx3, and Tx4, the cancellation apparatus 200 generates a cancellation signal that corresponds to the intermodulation signal, and multiplexes the cancellation signal with the reception signal.

A high-order distortion (e.g., a third-order distortion) such as an inter-phase modulation signal may occur from a single transmission signal such as, for example, the transmission signal Tx1, or may occur from a plurality of transmission signals such as, for example, the transmission signals Tx1 and Tx2 having different frequencies. In the present embodiment, it is assumed that the transmission signals Tx1 and Tx2 are irradiated to a source of distortion, and thus, an intermodulation signal is generated as a high-order distortion, and that a frequency of the intermodulation signal is included in a reception frequency band of each of the REs 300a and 300b. That is, the cancellation apparatus 200 cancels the intermodulation signal that is generated due to the intermodulation between the transmit signals Tx1 and Tx2, from the reception signal.

The cancellation apparatus 200 includes interfaces 210 and 240, a processor 220, and a memory 230.

The interface (IF) 210 is connected to the REC 100, and transmits and receives the baseband signal between the interface 210 itself and the REC 100. That is, the interface 210 receives the transmission signal that is generated by the processor 110, from the interface 130 of the REC 100. Furthermore, the interface 210 transmits the reception signals that are received by the REs 300a and 300b, to the interface 130 of the REC 100.

The processor 220 includes, for example, a CPU, an FPGA, or a DSP. Based on a plurality of transmission signals that are received by the interface 210, the processor 220 generates a cancellation signal for canceling the intermodulation signal. Furthermore, the processor 220 multiplexes the cancellation signal with the reception signal that is received by the interface (IF) 240, and cancels the intermodulation signal that is added to the reception signal. The functions of the processor 220 will be described in detail later.

The memory 230 includes, for example, a RAM or a ROM, and stores information which is used by the processor 220 to perform processing. That is, for example, the memory 230 stores parameters and so on that the processor 220 uses when generating the cancellation signal.

The interface 240 is connected to the REs 300a and 300b through, for example, an optical fiber, and transmits and receives the baseband signal between the interface 240 itself and the REs 300a and 300b. That is, the interface 240 transmits the transmission signals that are received from the REC 100, to the REs 300a and 300b. Furthermore, the interface 240 receives the reception signals that are received by the REs 300a and 300b, from the REs 300a and 300b. An intermodulation signal that is generated by the intermodulation between a signal at the frequency f1 and a signal at the frequency f2 is added to the reception signals that are received by the interface 240 from the REs 300a and 300b.

The REs 300a and 300b up-convert the baseband signals that are received from the cancellation apparatus 200, into the radio frequencies f1 and f2 and the wireless frequencies f3 and f4, respectively, and transmit the signals, through the antennas. That is, the RE 300a up-converts the transmission signals Tx1 and Tx2 into the frequencies f1 and f2, respectively, and transmits the signals from the antennas 310a and 311a. The RE 300b up-converts the transmission signals Tx3 and Tx4 into the frequencies f3 and f4, respectively, and transmits the signals from the antennas 310b and 311b. Furthermore, the REs 300a and 300b down-convert the reception signals that are received through the antennas, into the baseband frequency and transmit the signals to the cancellation apparatus 200. The intermodulation signal that is generated due to the intermodulation between the signals at the frequencies f1 and f2 described above is added to the reception signals that are received by the REs 300a and 300b.

Cancellation Signal

As described above, the processor 220 of the cancellation apparatus 200 generates the cancellation signal for the intermodulation signal that is generated due to the intermodulation between the transmission signals Tx1 and Tx2. The cancellation signal is a replica of the intermodulation signal that is generated due to a plurality of transmission signals, and, for example, Cancellation Equation (1) below may be used for the generation of the replica. However, Equation (1) is an equation for generating a cancellation signal C that, when a frequency (2f1−f2) is included in the reception frequency band, cancels a third-order distortion, a fifth-order distortion, and a seventh-order distortion in the reception frequency band.

$$C = \{ {p}_{11} {\vert Tx 1 \vert}^{4} + {p}_{21} {\vert Tx 1 \vert}^{2} \vert Tx 2 {\vert}^{2} + {p}_{31} {\vert Tx 2 \vert}^{4} + {p}_{41} {\vert Tx 1 \vert}^{2} + {p}_{51} {\vert Tx 2 \vert}^{2} + {p}_{61} \} \cdot \\ Tx 1 \cdot Tx 1 \cdot conj ( Tx 2 ) \qquad ( 1 )$$

In Equation (1), p₁₁ to p₆₁ are predetermined coefficients, and conj(x) indicates a complex conjugate of x. In a case where six coefficients, p₁₁ to p₆₁, are included in Cancellation Equation (1), and when the cancellation signal C is calculated using Cancellation Equation (1), these six coefficients are obtained, and then, the cancellation signal C is calculated.

FIG. 2 is a diagram illustrating a specific example of the number of coefficients in a cancellation equation. Since Equation (1) above is a cancellation equation for obtaining the third-order distortion, the fifth-order distortion, and the seventh-order distortion that is generated due to the transmission signals of two bands of the frequencies f1 and f2, the number of coefficients is 6. That is, it may be understood that as the number of bands increases, and the distortion to be considered becomes a higher order, the number of coefficients becomes greater, and it is difficult to calculate the cancellation signal C using the cancellation equation.

As described above, many coefficients are included in the cancellation equation, and the computation processing for calculating the cancellation signal C tends to be complicated. Accordingly, the processor 220 according to the first embodiment calculates a gain difference of an amplitude and a phase on a transmission path up to a source of distortion of the transmission signals Tx1 and Tx2 having different frequencies, and generates a cancellation equation that uses the gain difference. That is, the processor 220 calculates a gain difference “a” that satisfies Equation (2) described below in the source of distortion, and generates Cancellation Equation (3), which results from modifying Equation (1) described above using the gain difference “a.”

$$\begin{matrix}Tx 1 = a \cdot Tx 2 & ( 2 ) \\ C = \{ {S}_{7} / 32 \cdot ( 21 {\vert Tx 1 \vert}^{4} + 70 \cdot {a}^{2} \cdot {\vert Tx 1 \vert}^{2} {\vert Tx 2 \vert}^{2} + \\ 63 \cdot {a}^{4} \cdot {\vert Tx 2 \vert}^{4} ) + {S}_{5} / 8 \cdot ( 5 {\vert Tx 1 \vert}^{2} + 10 \cdot {a}^{2} \cdot {\vert Tx 2 \vert}^{2} ) + {S}_{3} \cdot 3 / 4 \} \cdot \\ Tx 1 \cdot Tx 1 \cdot conj ( a \cdot T x 2 ) & ( 3 )\end{matrix}$$

In Equation (3) described above, S₃, S₅, and S₇ are coefficients of the third-order distortion, the fifth-order distortion, and the seventh-order distortion, respectively. Therefore, whereas in a case where Cancellation Equation (1) is used, six coefficients, p₁₁ to p₆₁, are obtained and then the cancellation signal C is calculated, in a case where Cancellation Equation (3) is used, three coefficients, S₃, S₅, and S₇, are obtained and the cancellation C is calculated. Thus, it may be understood that an amount of computation processing may be reduced by using Cancelation Equation (3).

Basic Configuration of Cancellation Apparatus 200

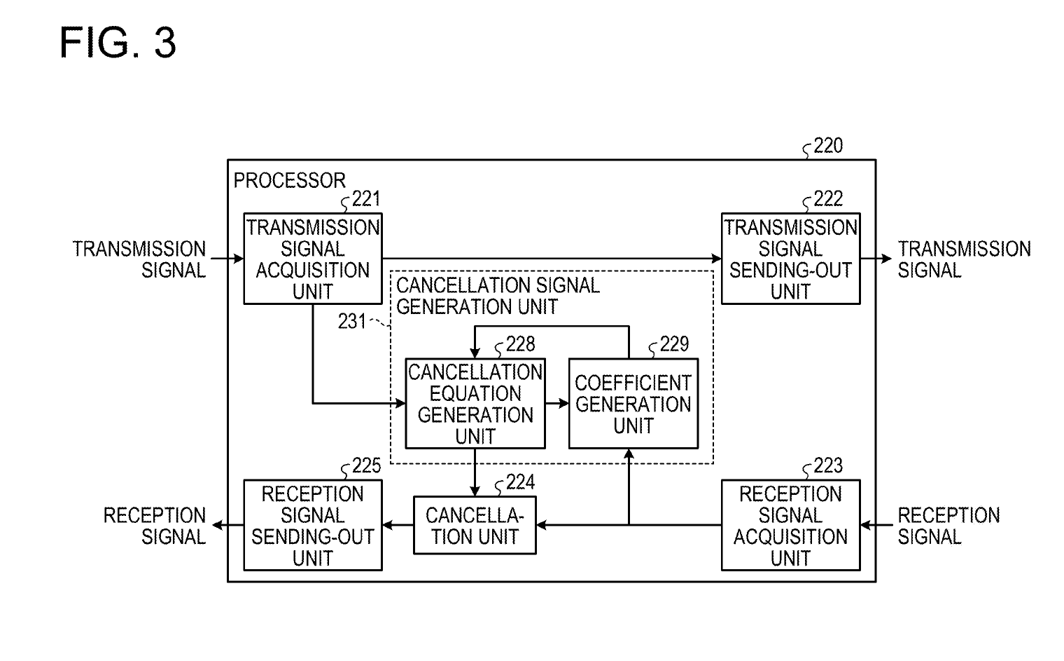

FIG. 3 a block diagram illustrating a function (a basic configuration) of the processor 220 of the cancellation apparatus 200. The processor 220 includes a transmission signal acquisition unit 221, a transmission signal sending-out unit 222, a reception signal acquisition unit 223, a cancellation unit 224, a reception signal sending-out unit 225, and a cancellation signal generation unit 231. The cancellation signal generation unit 231 includes a cancellation equation generation unit 228 and a coefficient determination unit 229.

The transmission signal acquisition unit 221 acquires the transmission signals that are received by the interface 210 from the REC 100. That is, the transmission signal acquisition unit 221 acquires the transmission signals Tx1, Tx2, Tx3, and Tx4.

The transmission signal sending-out unit 222 sends out the transmission signals that are acquired by the transmission signal acquisition unit 221, to the REs 300a and 300b through the interface 240. Specifically, the transmission signal sending-out unit 222 sends out the transmission signals Tx1 and Tx2 to the RE 300a, and sends out the transmission signals Tx3 and Tx4 to the RE 300b.

The reception signal acquisition unit 223 acquires the reception signals that are received by the interface 240 from the REs 300a and 300b. The intermodulation signal that is generated due to the intermodulation between the transmission signals Tx1 up-converted into the frequency f1 and Tx2 up-converted into the frequency f2 is added to the reception signals that are acquired by the reception signal acquisition unit 223.

The cancellation unit 224 multiplexes the cancellation signal C which is generated using the cancellation equation by the cancellation equation generation unit 228, with the reception signals. That is, the cancellation unit 224 multiplexes (adds) the cancellation signal C with (to) the reception signals to which the intermodulation signal is added, and thus, cancels the intermodulation signal.

The reception signal sending-out unit 225 sends out the reception signals from which the intermodulation signal has been canceled, to the REC 100 through the interface 210.

In the cancellation signal generation unit 231, the cancellation equation generation unit 228 generates a third-order intermodulation distortion (a third-order intermodulation signal) from, for example, the transmission signals Tx1 and Tx2 that are acquired by the transmission signal acquisition unit 221. Then, the cancellation equation generation unit 228 generates a cancellation equation for generating the cancellation signal C, from the generated third-order intermodulation signal. Specifically, the cancellation equation generation unit 228 generates Equation (3) described above. Furthermore, when coefficients of the cancellation equation are determined by the coefficient determination unit 229, the cancellation equation generation unit 228 outputs the cancellation signal C that is generated by the cancellation equation, to the cancellation unit 224.

In the cancellation signal generation unit 231, the coefficient determination unit 229 determines the coefficients that are included in the cancellation equation by using, for example, a least square method. That is, the coefficient determination unit 229 determines the coefficients S₃, S₅, and S₇ that are included in Equation (3) described above by, for example, a least square method using the reception signal Rx1. Furthermore, the coefficient determination unit 229 may determine the coefficients S₃, S₅, and S₇ at which a correlation between the cancellation signal C and the reception signal Rx1 is maximized. Then, the coefficient determination unit 229 notifies the cancellation equation generation unit 228 of the determined coefficients S₃, S₅, and S₇.

Problem and Solution

Here, a problem of the related art and a solution to the problem in the first embodiment will be described with specific examples.

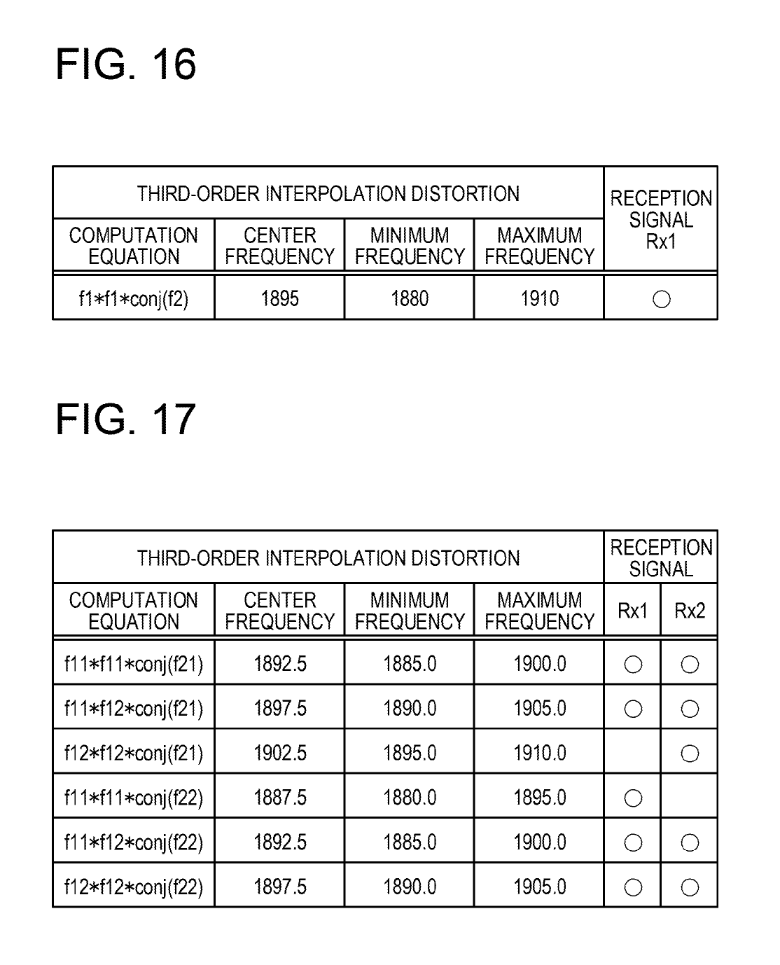

For example, in LTE, it is assumed that the frequency bandwidth of LTE is 10 MHz, and the center frequency of the reception signal Rx1 is 1895 [MHz]. The reception frequency band of the reception signal Rx1 ranges from 1880 MHz to 1890 MHz. In this case, in LTE, because a signal of a bandwidth corresponding to each transmission frequency band is used, a third-order intermodulation distortion, f1*f1*conj(f2), may be canceled, as one third-order intermodulation distortion, for the reception signal Rx1 (see, e.g., FIG. 16). In this manner, in LTE, in a case where a third-order intermodulation distortion is generated from the transmission signals of the two carriers, one circuit that generates the third-order intermodulation distortion may be provided in the cancellation equation generation unit 228.

However, in W-CDMA, in the case where a bandwidth is determined on a per-carrier basis and a plurality of carriers are present for each transmission frequency band, there is a problem in that the types of third-order intermodulation distortions increase exponentially, and the circuit scale of the apparatus increases.

For example, it is assumed that a signal is W-CDMA, and the center frequencies of the transmission signals are f11=1932.5 [MHz], f12=1937.5 [MHz], f21=1972.5 [MHz], and f22=1977.5 [MHz]. The reception frequency band of the reception signal Rx1 ranges from 1890 MHz to 1895 MHz, and the reception frequency band of the reception signal Rx2 ranges from 1895 MHz to 1900 MHz. In this case, in W-CDMA, five third-order intermodulation distortions are canceled for the reception signals Rx1 and Rx2 (see, e.g., FIG. 17). In this manner, in W-CDMA, in a case where third-order intermodulation distortions are generated from the transmission signals of the four carriers, the cancellation equation generation unit 228 requires five circuits that generate the third-order intermodulation distortions for the reception signals Rx1 and Rx2.

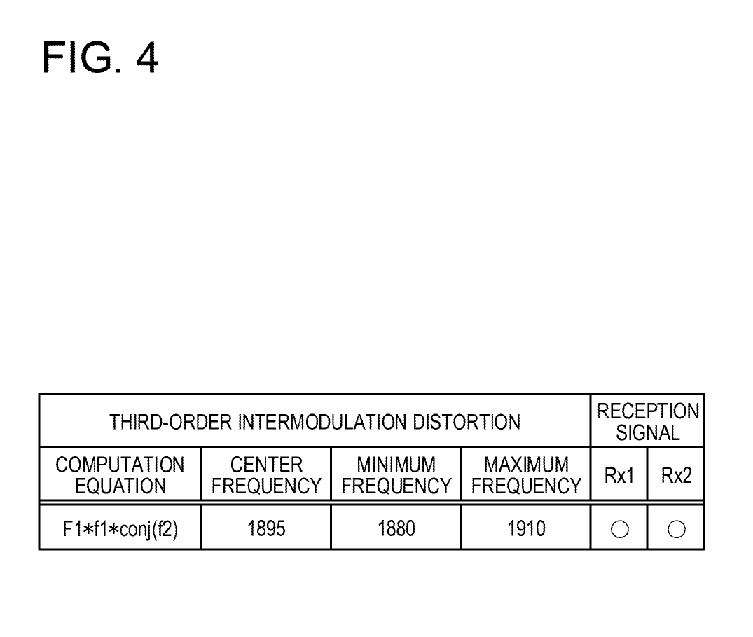

Accordingly, in order to solve the problem described above, in the first embodiment, at least one set of transmission signals among the plurality of transmission signals are multiplexed with each other. FIG. 4 is an explanatory diagram illustrating an example of a third-order intermodulation distortion that is a cancellation target for the reception signal in the wireless communication system according to the first embodiment.

For example, in the first embodiment, among the plurality of transmission signals, the transmission signals Tx1 and Tx2 (transmission signals Tx11 and Tx12, in this case) that are transmitted at the different frequencies f11 and f12, respectively, are multiplexed with each other. Furthermore, in the first embodiment, among the plurality of transmission signals, the transmission signals Tx4 and Tx4 (transmission signals Tx21 and Tx22, in this case) that are transmitted at the different frequencies f21 and f23, respectively, are multiplexed with each other. In this manner, in the first embodiment, at least one set of transmission signals among the plurality of transmission signals are multiplexed with each other. Thus, the frequencies f11 and f12 are aggregated into the frequency f1, and the frequencies f21 and f22 are aggregated into the frequency f2.

In the first embodiment, instead of simply generating third-order intermodulation distortions from the transmission signals of the four carriers, the cancellation equation generation unit 228 multiplexes the transmission signals of the four carriers into the transmission signals of the two carriers and generates a third-order intermodulation distortion from the transmission signals of the two carries that result from the multiplexing. Therefore, as illustrated in FIG. 4, in the first embodiment, the third-order intermodulation, f1*f1*conj(f2), may be canceled, as one third-order intermodulation distortion, for the reception signals Rx1 and Rx2. In this case, one circuit that generates the third-order intermodulation distortion for the reception signals Rx1 and Rx2 may be provided in the cancellation equation generation unit 228.

Configuration of Cancellation Apparatus 200 for Solving the Above-Described Problem

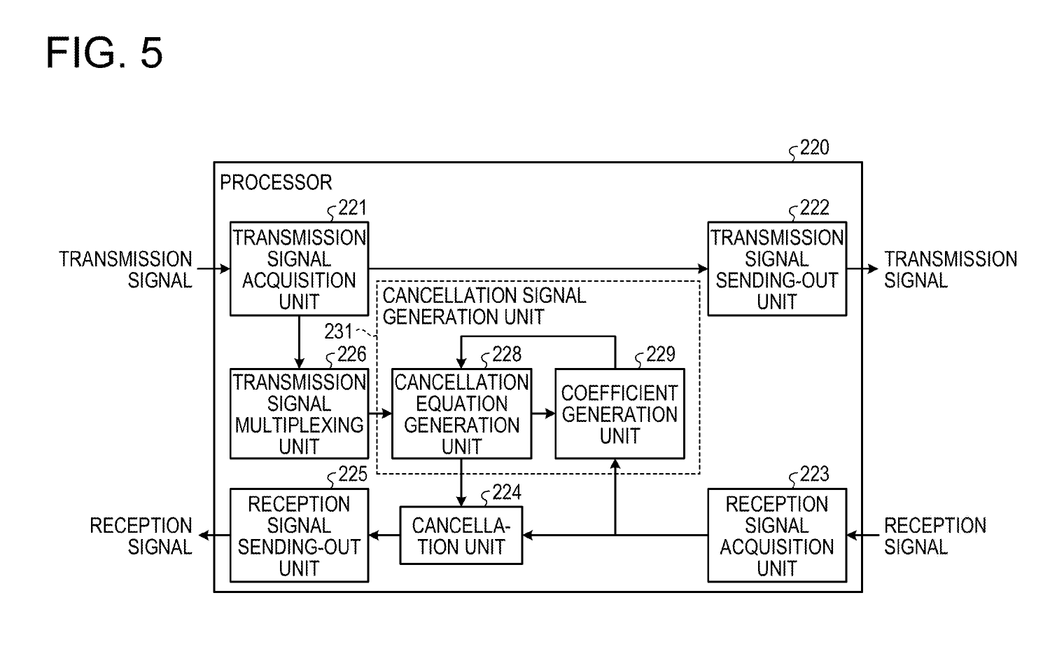

FIG. 5 is a block diagram illustrating an example of a function of the processor 220 of the cancellation apparatus 200 in the wireless communication system according to the first embodiment. The processor 220 further includes a transmission signal multiplexing unit 226, in addition to the basic configuration of FIG. 3.

The transmission signal multiplexing unit 226 multiplexes the transmission signals Tx1 and Tx2 acquired by the transmission signal acquisition unit 221, with each other. That is, the transmission signal multiplexing unit 226 multiplexes the transmission signals Tx11 and Tx12 that are transmitted at the different frequencies f11 and f12, respectively, with each other, and thus, generates a multiplex transmission signal. As a result, the frequencies f11 and f12 are aggregated into the frequency f1. The multiplex transmission signal at the frequency f1 that results from the aggregation is output, as the transmission signal Tx1, to the cancellation signal generation unit 231. Furthermore, the transmission signal multiplexing unit 226 multiplexes the transmission signals Tx11 and Tx12 that are transmitted at the different frequencies f21 and f22, respectively, with each other, and thus, generates a multiplexed transmission signal. As a result, the frequencies f21 and f22 are aggregated into the frequency f2. The multiplexed transmission signal at the frequency f2 that results from the aggregation is output as the transmission signal Tx2, to the cancellation signal generation unit 231.

In the cancellation signal generation unit 231, the cancellation equation generation unit 228 generates one third-order intermodulation distortion for the reception signals Rx1 and Rx2, from the transmission signals Tx1 and Tx2 at the frequencies f1 and f2, respectively, that result from the aggregation by the transmission signal multiplexing unit 226. Then, the cancellation equation generation unit 228 generates a cancellation equation for generating the cancellation signal C from the generated one third-order intermodulation distortion, for the reception signals Rx1 and Rx2. That is, Equation (3) described above is generated by the cancellation equation generation unit 228. Accordingly, the cancellation equation generation unit 228 generates the cancellation signal C for the reception signals Rx1 and Rx2, based on the generated cancellation equation and the coefficients that are determined by the coefficient determination unit 229. The generated cancellation signal C is output to the cancellation unit 224.

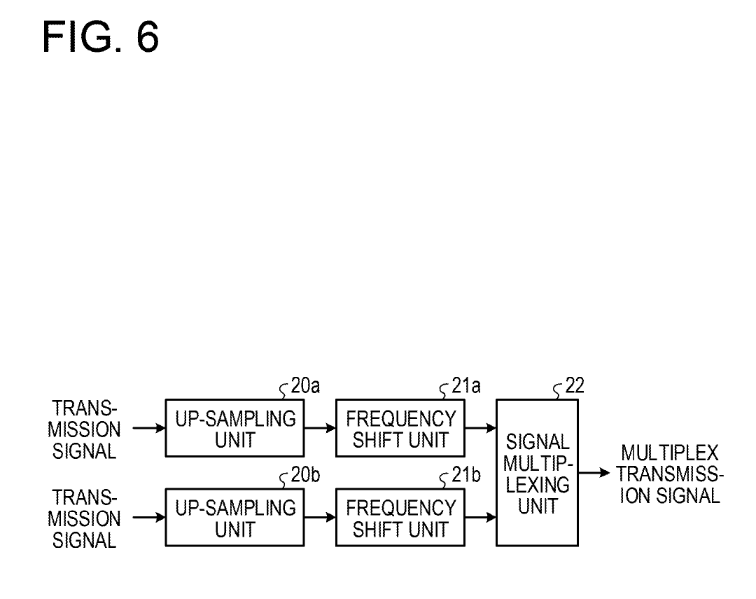

FIG. 6 is a block diagram illustrating an example of a configuration of the transmission signal multiplexing unit 226 of the cancellation apparatus 200 in the wireless communication system according to the first embodiment. The transmission signal multiplexing unit 226 includes up-sampling units 20a and 20b, frequency shift units 21a and 21b, and a signal multiplexing unit 22.

The transmission signal Tx11 that is acquired by the transmission signal acquisition unit 221 is subjected to a signal rate conversion processing by the up-sampling unit 20a, and subjected to a frequency shift processing by the frequency shift unit 21a. Furthermore, the transmission signal Tx12 acquired by the transmission signal acquisition unit 221 is subjected to a signal rate conversion processing by the up-sampling unit 20b, and subjected to frequency shift processing by the frequency shift unit 21b. Thereafter, the transmission signals Tx11 and Tx12 are multiplexed with each other by the signal multiplexing unit 22, and the transmission signal Tx1 is generated as the multiplex transmission signal. The transmission signal Tx1 is sent out to the cancellation equation generation unit 228.

In the same manner, the transmission signal Tx21 acquired by the transmission signal acquisition unit 221 is subjected to a signal rate conversion processing by the up-sampling unit 20a, and subjected to a frequency shift processing by the frequency shift unit 21a. Furthermore, the transmission signal Tx22 acquired by the transmission signal acquisition unit 221 is subjected to a signal rate conversion processing by the up-sampling unit 20b, and subjected to a frequency shift processing by the frequency shift unit 21b. Thereafter, the transmission signals Tx21 and Tx22 are multiplexed with each other by the signal superposition unit 22, and the transmission signal Tx2 is generated as the multiplex transmission signal. The multiplex transmission signal Tx2 is sent out to the cancellation equation generation unit 228.

Thus, the cancellation equation generation unit 228 would have originally required five circuits that generate the third-order intermodulation distortion for the reception signals Rx1 and Rx2. However, in the first embodiment, one circuit that generates the third-order intermodulation distortion may be sufficient. Therefore, in the wireless communication system according to the first embodiment, the amount of computation processing is suppressed from being increased, and thus, the circuit scale may be reduced.

Distortion Cancellation Processing

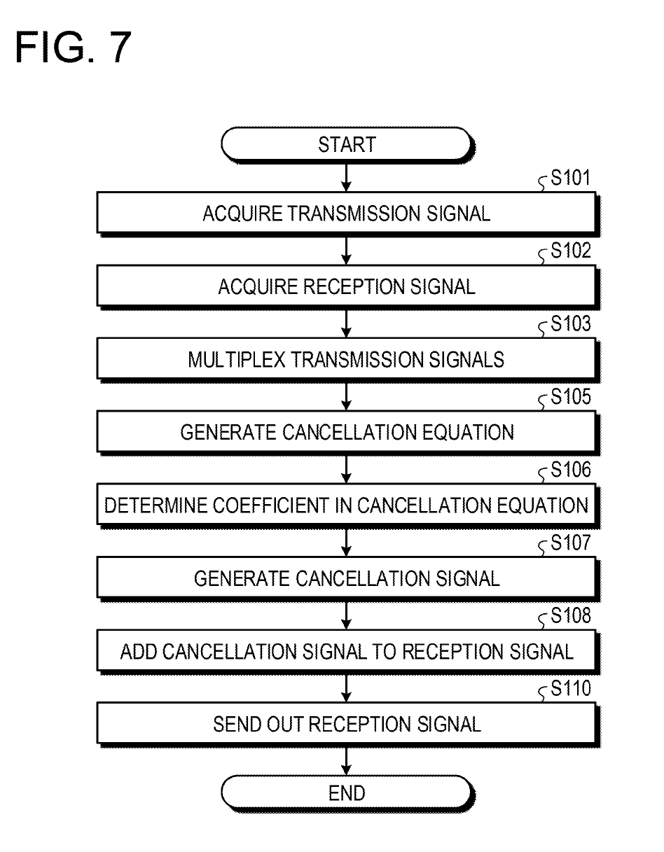

FIG. 7 is a flowchart illustrating an example of a distortion cancellation processing by the cancellation apparatus 200 in the wireless communication system according to the first embodiment.

The transmission signals Tx11, Tx12, Tx21, and Tx22 that are transmitted from the REC 100 are acquired by the transmission signal acquisition unit 221 of the processor 220 through the interface 210 (Operation S101). The transmission signals acquired by the transmission signal acquisition unit 221 are sent out from the transmission signal sending-out unit 222 to the REs 300a and 300b through the interface 240. Meanwhile, the reception signals Rx1 and Rx2 that are received by the REs 300a and 300b are acquired by the reception signal acquisition unit 223 of the processor 220 through the interface 240 (Operation S102). The intermodulation signals that result from the intermodulation between the transmit signals Tx11 and Tx12 and the intermodulation between the transmit signals Tx21 and Tx22 are added to the reception signals Rx1 and Rx2, respectively, in the RE 300a and the RE 300b.

When the transmission signals and the reception signals are acquired, among the transmission signals Tx11, Tx12, Tx21, and Tx22, the transmission signals Tx11 and Tx12 that are transmitted at the different frequencies f11 and f12, respectively, are multiplexed with each other by the transmission signal multiplexing unit 226 of the processor 220. That is, the frequencies f11 and f12 are aggregated into the frequency f1. Furthermore, among the transmission signals Tx11, Tx12, Tx21, and Tx22, the transmission signals Tx21 and Tx22 that are transmitted at the different frequencies f21 and f22, respectively, are multiplexed with each other by the transmission signal multiplexing unit 226. That is, the frequencies f21 and f22 are aggregated into the frequency f2 (Operation S103). The multiplex transmission signals at the frequencies f1 and f2, respectively, that result from the aggregation are output, as the transmission signals Tx1 and Tx2, to the cancellation signal generation unit 231.

Thereafter, one third-order intermodulation is generated, by the cancellation equation generation unit 228 of the cancellation signal generation unit 231, from the transmission signals Tx1 and Tx2 at the frequencies f1 and f2, respectively, that result from the aggregation, for the reception signals Rx1 and Rx2. Then, a cancellation equation for generating the cancellation signal C is generated, by the cancellation equation generation unit 228, from the generated one third-order intermodulation distortion, for the reception signals Rx1 and Rx2 (Operation S105). That is, Equation (3) described above is generated by the cancellation equation generation unit 228. Then, the coefficient determination unit 229 determines coefficients of the cancellation equation by performing, for example, a least square method or correlation detection using the receptions signals Rx1 and Rx2 (Operation S106). Here, coefficients S3, S5, and S7 of Equation (3) described above are determined by the coefficient determination unit 229.

When the coefficients are determined, the cancellation signal C may be generated by the cancellation equation, and thus, the cancellation signal C is generated by the cancellation equation generation unit 228 for the reception signals Rx1 and Rx2 (Operation S107). The generated cancellation signal C is output to the cancellation unit 224. Then, the cancellation signal C is multiplexed (added) by the cancellation unit 224 with (to) the reception signals Rx1 and Rx2 (Operation S108), so that the intermodulation signals that are added to the reception signals Rx1 and Rx2 are canceled. The reception signals Rx1 and Rx2 from which the intermodulation signals have been canceled are sent out by the reception signal sending-out unit 225 to the RC 100 through the interface 210 (Operation S110).

In the first embodiment, among the plurality of transmission signals Tx11, Tx12, Tx21, and Tx22, the transmission signal multiplexing unit 226 multiplexes the transmission signals Tx11 and Tx12 with each other and multiplexes the transmission signals Tx21 and Tx22 with each other. However, the present disclosure is not limited thereto. For example, in a case where the frequencies f11 and f12 correspond to W-CDMA and the frequency f2 corresponds to LTE, in FIG. 7, among the plurality of transmission signals Tx11, Tx12, and Tx2, the transmission signal multiplexing unit 226 multiplexes the transmission signals Tx11 and Tx12 with each other, and does not multiplex the transmission signal Tx2. Specifically, the transmission signal multiplexing unit 226 multiplexes the transmission signals Tx11 and Tx12 that are transmitted at the different frequencies f11 and f12, respectively, with each other, and thus, generates a multiplex transmission signal. As a result, the frequencies f11 and f12 are aggregated into the frequency f1 (Operation S103). The multiplex transmission signal at the frequency f1 that results from the aggregation is output, as the transmission signal Tx1, to the cancellation signal generation unit 231. Furthermore, the transmission signal Tx2 that is transmitted at the frequency f2 is not multiplexed.

In this case, in the cancellation signal generation unit 231, the cancellation equation generation unit 228 generates one third-order intermodulation distortion from the transmission signal Tx1 (the multiplex transmission signal) at the frequency f1 that results from the aggregation by the transmission signal multiplexing unit 226 and the transmission signal Tx2 that are transmitted at the frequency f2. Accordingly, the cancellation equation generation unit 228 generates a cancellation equation for generating the cancellation signal C from the generated one third-order intermodulation distortion, for the reception signals Rx1 and Rx2 (Operation S105). When coefficients of the cancellation equation are determined by the coefficient determination unit 229, the cancellation equation generation unit 228 outputs the cancellation signal C that is generated by the cancellation equation to the cancellation unit 224 (Operation S107). Then, the cancellation signal C is multiplexed (added) by the cancellation unit 224 with (to) the reception signals Rx1 and Rx2 so that the intermodulation signals added to the reception signals Rx1 and Rx2 are canceled (Operation S108).

As described above, the distortion cancellation apparatus (the cancellation apparatus 200) in the wireless communication system according to the first embodiment includes the transmission signal acquisition unit 221, the reception signal acquisition unit 223, the cancellation signal generation unit 231, and the cancellation unit 224. The cancellation apparatus 200 further includes the transmission signal multiplexing unit 226. The transmission signal acquisition unit 221 acquires the plurality of transmission signals Tx11, Tx12, Tx21, and Tx22 that are wirelessly transmitted at the different frequencies. The reception signal acquisition unit 223 acquires the plurality of reception signals Rx1 and Rx2 to which the intermodulation signals (the third-order intermodulation distortions) that are generated due to the plurality of transmission signals Tx11,Tx12, Tx21, and Tx22) are added. The transmission signal multiplexing unit 226 multiplexes at least one set of transmission signals among the plurality of transmission signals Tx11, Tx12, Tx21, and Tx22, and thus, generates at least one multiplex transmission signal (e.g., the multiplex transmission signal Tx1 or Tx2). The cancellation signal generation unit 231 generates the cancellation signal C that corresponds to the intermodulation signal, by a computation equation using the multiplex transmission signals Tx1 and Tx2 and the plurality of reception signals Rx1 and Rx2. Based on the cancellation signal C, the cancellation unit 224 cancels the intermodulation signals that are added to the plurality of reception signals Rx1 and Rx2.

In this manner, in the wireless communication system according to the first embodiment, first, among the plurality of transmission signals Tx11, Tx12, Tx21, and Tx22, at least one set of transmission signals are multiplexed with each other, and thus, at least one multiplex transmission signal (the multiplex transmission signal Tx1 or Tx2) is generated. Thereafter, the cancellation signal C is generated by the computation equation using the multiplex transmission signals Tx1 and Tx2 and the plurality of reception signals Rx1 and Rx2. Thus, in the wireless communication system according to the first embodiment, in comparison with the related art, the amount of computation processing for calculating the intermodulation signal (the third-order intermodulation distortion) may be suppressed from being increased, and the circuit scale of the apparatus may be reduced.

Furthermore, in the wireless communication system according to the first embodiment, the cancellation signal generation unit 231 generates the cancellation signal C by the computation equation using at least one multiplex transmission signal (the multiplex transmission signal Tx1), the transmission signal Tx2, and the plurality of reception signals Rx1 and Rx2. The transmission signal Tx2 is a transmission signal that is not multiplexed among the plurality of transmission signals Tx11, tx12, and Tx2. In this case as well, in the wireless communication system according to the first embodiment, in comparison with the related art, the amount of computation processing for calculating the intermodulation signal (the third-order intermodulation distortion) may be suppressed from being increased, and the circuit scale of the apparatus may be reduced.

In the first embodiment, among the plurality of transmission signals, at least one set of transmission signals are multiplexed with each other. However, the present disclosure is not limited thereto. Among the plurality of reception signals, at least one set of reception signals may be multiplexed with each other. An embodiment in this case will be described as a second embodiment. In the second embodiment, components similar to those in the first embodiment will be given the same reference numerals as used in the first embodiment, and thus, descriptions of overlapping components and operations will be omitted.

### Second Embodiment

Problem and Solution

First, a problem of the related art and a solution to the problem in the second embodiment will be described with specific examples.

For example, it is assumed that a signal is W-CDMA, and the center frequencies of the transmission signals are f11=1932.5 [MHz], f12=1937.5 [MHz], f21=1972.5 [MHz], and f22=1977.5 [MHz]. The reception frequency band of the reception signal Rx1 ranges from 1890 MHz to 1895 MHz, and the reception frequency band of the reception signal Rx2 ranges from 1895 MHz to 1900 MHz. In this case, in W-CDMA, five third-order intermodulation distortions are canceled for the reception signals Rx1 and Rx2 (see, e.g., FIG. 17). In this manner, in W-CDMA, in a case where third-order intermodulation distortions are generated from the transmission signals of the four carriers, the cancellation equation generation unit 228 requires five circuits that generate the third-order intermodulation distortions, for the reception signals Rx1 and Rx2.

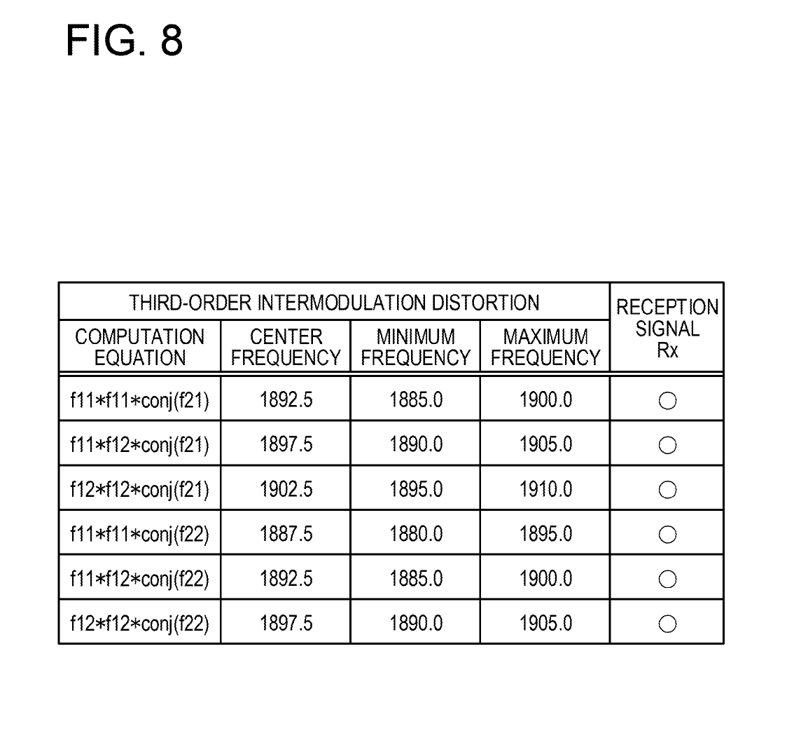

Accordingly, in order to solve the problem described above, in the second embodiment, at least one set of transmission signals are multiplexed with each other among the plurality of reception signals. FIG. 8 is an explanatory diagram illustrating an example of a third-order intermodulation distortion that is a cancellation target for a reception signal in a wireless communication system according to the second embodiment.

For example, in the second embodiment, among the plurality of reception signals, the reception signals Rx1 and Rx2 are multiplexed with each other. In this manner, in the second embodiment, the reception signals Rx1 and Rx2 are multiplexed with each other, and thus, the reception signals Rx1 and Rx2 may be aggregated into a reception signal Rx.

Therefore, as illustrated in FIG. 8, in the second embodiment, six third-order intermodulation distortions may be canceled for the reception signal Rx. In this case, six circuits that generate the third-order intermodulation distortions for the reception signal Rx may be provided in the cancellation equation generation unit 228.

### Configuration of Cancellation Apparatus 200 to Solve the Above-Described Problem

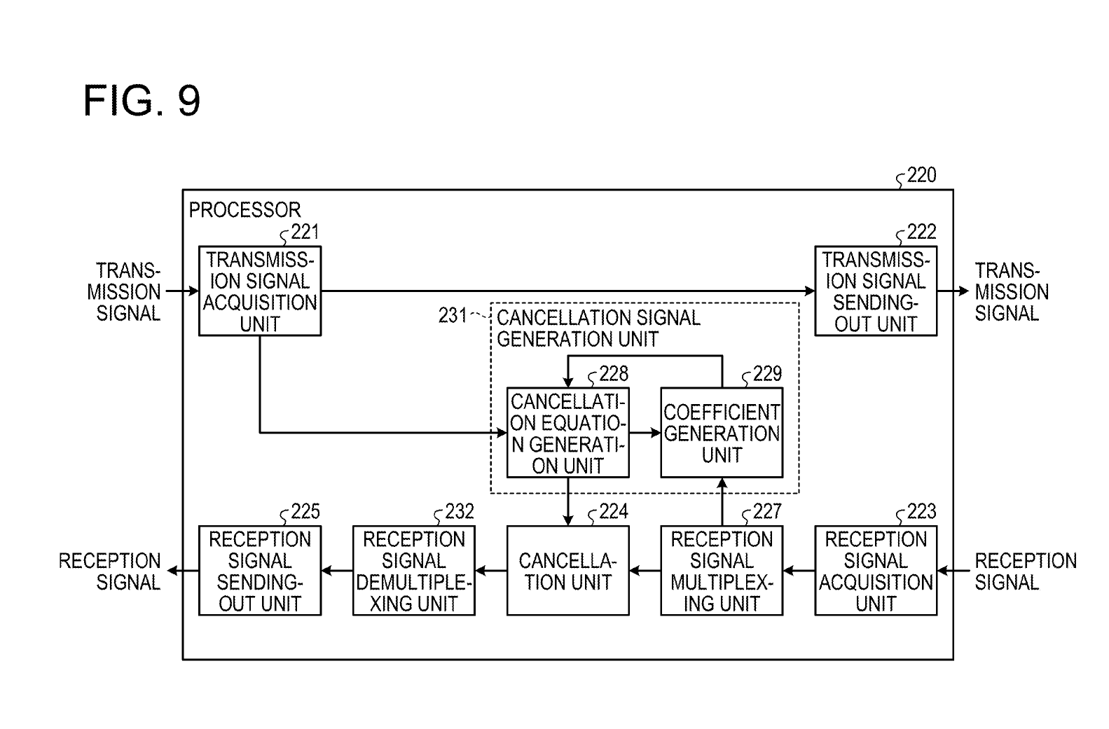

FIG. 9 is a block diagram illustrating an example of a function of the processor 220 of the cancellation apparatus 200 in the wireless communication system according to the second embodiment. The processor 220 further includes a reception signal multiplexing unit 227 and a reception signal demultiplexing unit 232, in addition to the basic configuration of FIG. 3.

The reception signal multiplexing unit 227 multiplexes the reception signals Rx1 and Rx2 that are acquired by the reception signal acquisition unit 223. That is, the reception signal multiplexing unit 227 multiplexes the reception signals Rx1 and Rx2 with each other, and thus, generates a multiplex reception signal. The multiplex reception signal is output as the reception signal Rx to the coefficient determination unit 229 and the cancellation unit 224.

In the cancellation signal generation unit 231, the cancellation equation generation unit 228 generates six third-order intermodulation distortions for the reception signal Rx from the transmission signals Tx11, Tx12, Tx21, and Tx22 that are acquired by the transmission signal acquisition unit 221. Then, the cancellation equation generation unit 228 generates a cancellation equation for generating the cancellation signal C from the generated six third-order intermodulation distortions for the reception signal Rx. That is, Equation (3) described above is generated by the cancellation equation generation unit 228. Accordingly, the cancellation equation generation unit 228 generates the cancellation signal C for the reception signal Rx, based on the generated cancelation equation and the coefficients determined by the coefficient determination unit 229. The generated cancellation signal C is output to the cancellation unit 224.

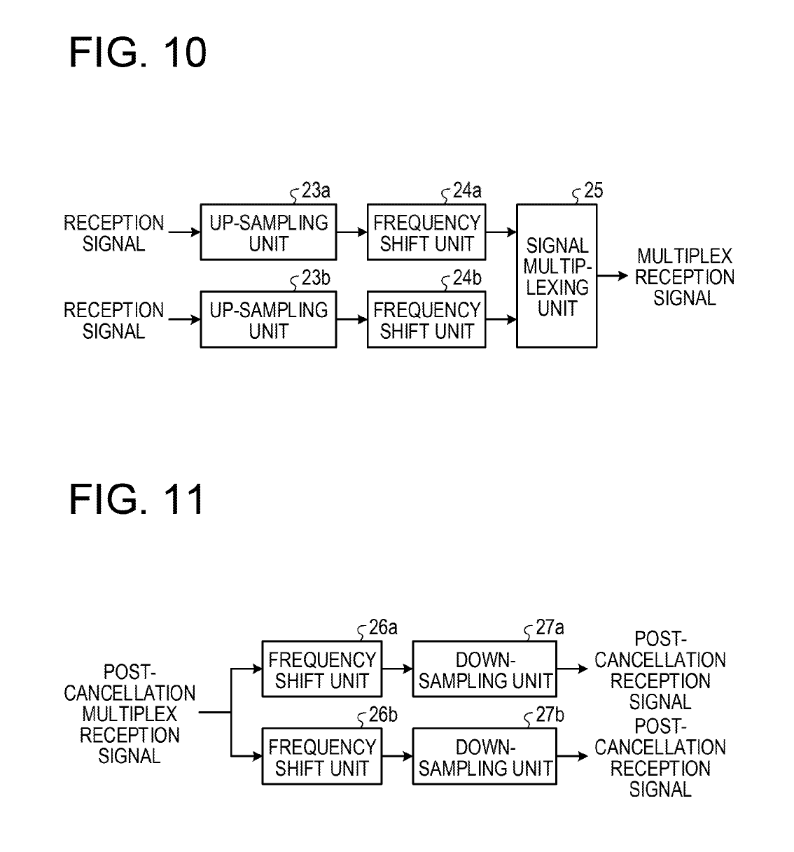

FIG. 10 is a block diagram illustrating an example of a configuration of the reception signal multiplexing unit 227 of the cancellation apparatus 200 in the wireless communication system according to the second embodiment. The reception signal multiplexing unit 227 includes up-sampling units 23a and 23b, frequency shift units 24a and 24b, and a signal multiplexing unit 25.

The reception signal Rx1 acquired by the reception signal acquisition unit 223 is subjected to a signal rate conversion processing by the up-sampling unit 23a, and subjected to a frequency shift processing by the frequency shift unit 24a. Furthermore, the reception signal Rx2 acquired by the reception signal acquisition unit 223 is subjected to a signal rate conversion processing by the up-sampling unit 23b, and subjected to a frequency shift processing by the frequency shift unit 24b. Thereafter, the reception signals Rx1 and Rx2 are multiplexed with each other by the signal multiplexing unit 25, and the reception signal Rx is generated as the multiplex reception signal. The reception signal Rx is sent out to the coefficient determination unit 229 and the cancellation unit 224.

FIG. 11 is a block diagram illustrating an example of a configuration of the reception signal demultiplexing unit 232 of the cancellation apparatus 200 in the wireless communication system according to the second embodiment. The reception signal demultiplexing unit 232 includes frequency shift units 26a and 26b, down-sampling units 27a and 27b, and a signal demultiplexing unit 28.

The reception signal Rx (the multiplex reception signal) from which the intermodulation signal has been canceled by the cancellation unit 224 is subjected to a frequency shift processing by the frequency shift units 26a and 26b. The reception signals that have been subjected to the frequency shift processing by the frequency shift units 26a and 26b are subjected to a signal rate conversion processing by the down-sampling units 27a and 27b, respectively, and the reception signals Rx1 and Rx2 are generated as the reception signals from which the intermodulation signal has been canceled. The reception signals Rx1 and Rx2 are sent out to the reception signal sending-out unit 225.

Thus, the cancellation equation generation unit 228 would have originally required five circuits that generate the third-order intermodulation distortions, for the reception signals Rx1 and Rx2. However, in the configuration of the second embodiment, only one circuit that generates the third-order intermodulation distortions may be sufficient for the reception signal Rx. Therefore, in the wireless communication system according to the second embodiment, the amount of computation processing is suppressed from being increased, and thus, the circuit scale may be reduced.

Distortion Cancellation Processing

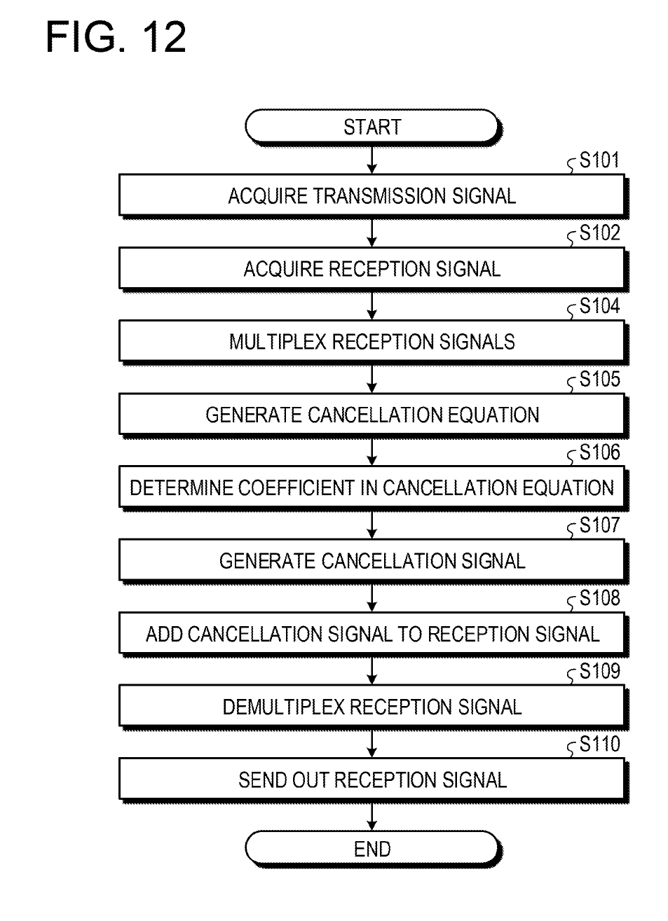

FIG. 12 is a flowchart illustrating an example of the distortion cancellation processing by the cancellation apparatus 200 in the wireless communication system according to the second embodiment.

The transmission signals Tx11, Tx12, Tx21, and Tx22 that are transmitted from the REC 100 are acquired by the transmission signal acquisition unit 221 of the processor 220 through the interface 210 (Operation S101). The transmission signals that are acquired by the transmission signal acquisition unit 221 are sent out from the transmission signal sending-out unit 222 to the REs 300a and 300b through the interface 240. Meanwhile, the reception signals Rx1 and Rx2 that are received by the REs 300a and 300b are acquired by the reception signal acquisition unit 223 of the processor 220 through the interface 240 (Operation S102). The intermodulation signals that result from the intermodulation between the transmission signals Tx11 and Tx12 and the intermodulation between the transmission signals Tx21 and Tx22 are added to the reception signals Rx1 and Rx2, respectively, in the REs 300a and 300b.

When the transmission signals and the reception signals are acquired, the reception signals Rx1 and Rx2 are multiplexed with each other by the reception signal multiplexing unit 227 of the processor 220. That is, the reception signals Rx1 and Rx2 are aggregated into a reception signal Rx (Operation S104). The reception signal Rx (the multiplex reception signal) is output to the coefficient determination unit 229 and the cancellation unit 224.

Thereafter, six third-order intermodulation distortions for the reception signal Rx are generated, by the cancellation equation generation unit 228 of the cancellation signal generation unit 231, from the transmission signals Tx11, Tx12, Tx21, and Tx22 that are acquired by the transmission signal acquisition unit 221. Then, a cancellation equation for generating the cancellation signal C is generated, by the cancellation equation generation unit 228, from the generated six third-order intermodulation distortions, for the reception signal RX (Operation S105). That is, Equation (3) described above is generated by the cancellation equation generation unit 228. Then, the coefficient determination unit 229 determines coefficients of the cancellation equation by performing, for example, the least squares method or the correlation detection using the reception signal Rx (Operation S106). At this point, the coefficients S3, S5, and S7 in Equation (3) described above are determined by the coefficient determination unit 229.

In the case where the coefficients are determined, the cancellation signal C may be generated by the cancellation equation. Thus, the cancellation signal C is generated, by the cancellation equation generation unit 228, for the reception signal Rx (Operation S107). The generated cancellation signal C is output to the cancellation unit 224. Then, the cancellation signal C is multiplexed (added) by the cancellation unit 224 with (to) the reception signal Rx (Operation S108), and thus, the intermodulation signal added to the reception signal Rx is canceled. The reception signal Rx from which the intermodulation signal has been canceled is demultiplexed by the reception signal demultiplexing unit 232 into the reception signals Rx1 and Rx2 (Operation S109). Thereafter, the reception signals Rx1 and Rx2 are sent out by the reception signal sending-out unit 225 to the REC 100 through the interface 210 (Operation S110).

In the second embodiment, the reception signal multiplexing unit 227 multiplexes the reception signals Rx1 and Rx2. However, the present disclosure is not limited thereto. For example, in a case where the reception signals Rx1 and Rx2 correspond to W-CDMA, and a reception signal Rx3 corresponds to LTE, in FIG. 12, the reception signal multiplexing unit 227 multiplexes the reception signals Rx1 and Rx2 with each other, and does not multiplex the reception signal Rx3, among the plurality of reception signals. Specifically, the reception signal multiplexing unit 227 multiplexes the reception signals Rx1 and Rx2 with each other, and thus, generates a multiplex reception signal. As a result, the reception signals Rx1 and Rx2 are aggregated into the reception signal Rx (Operation S104). The reception signal Rx (the multiplex reception signal) is output to the coefficient determination unit 229 and the cancellation unit 224. Furthermore, the reception signal Rx3 is not multiplexed.

In this case, in the cancellation signal generation unit 231, the cancellation equation generation unit 228 generates six third-order intermodulation distortions from the transmission signals Tx11, Tx12, Tx21, and Tx22 that are acquired by the transmission signal acquisition unit 221. Accordingly, the cancellation equation generation unit 228 generates a cancellation equation for generating the cancellation signal C from the generated six third-order intermodulation distortions, for the reception signal Rx and the reception signal Rx3 (Operation S105). When coefficients of the cancellation equation are determined by the coefficient determination unit 229, the cancellation equation generation unit 228 outputs the cancellation signal C that is generated by the cancellation equation, to the cancellation unit 224 (Operation S107). Then, the cancellation signal C is multiplexed (added) by the cancellation unit 224 with (to) the reception signal Rx and the reception signal Rx3, and thus, the intermodulation signals that are added to the reception signal Rx and the reception signal Rx3 are canceled (Operation S108).

As described above, the distortion cancellation apparatus (the cancellation apparatus 200) in the wireless communication system according to the second embodiment includes the transmission signal acquisition unit 221, the reception signal acquisition unit 223, the cancellation signal generation unit 231, and the cancellation unit 224. The cancellation apparatus 200 further includes the reception signal multiplexing unit 227 and the reception signal demultiplexing unit 232. The transmission signal acquisition unit 221 acquires the plurality of transmission signals Tx11, Tx12, Tx21, and Tx22 that are wirelessly transmitted at different frequencies. The reception signal acquisition unit 223 acquires the plurality of reception signals Rx1 and Rx2 to which the intermodulation signals (the third-order intermodulation distortions) that are generated due to the plurality of transmission signals Tx11,Tx12, and Tx22 are added. The reception signal multiplexing unit 227 multiplexes at least one set of reception signals with each other, from the plurality of reception signals Rx1 and Rx2, and thus, generates at least one multiplex reception signal (e.g., the multiplex reception signal Rx). The cancellation signal generation unit 231 generates the cancellation signal C that corresponds to the intermodulation signals, by a computation equation using the plurality of transmission signals Tx11, Tx12, Tx21, and Tx22 and the multiplex reception signal Rx. Based on the cancellation signal C, the cancellation unit 224 cancels the intermodulation signals that are added to the multiplex reception signal Rx. The reception signal demultiplexing unit 232 demultiplexes the multiplex reception signal Rx from which the intermodulation signals have been canceled, into the plurality of reception signals Rx1 and Rx2.

In this manner, in the wireless communication system according to the second embodiment, first, at least one set of reception signals from the plurality of reception signals Rx1 and Rx2 are multiplexed with each other, and thus, at least one multiplex reception signal (e.g., the multiplex reception signal Rx) is generated. Thereafter, the cancellation signal C is generated by the computation equation using the plurality of transmission signals Tx11, Tx12, Tx21, and Tx22 and the multiplex reception signal Rx. For this reason, in the wireless communication system according to the second embodiment, in comparison with the related art, the amount of computation processing for calculating the intermodulation signals (the third-order intermodulation distortions) may be suppressed from being increased, and the circuit scale of the apparatus may be reduced.

Furthermore, in the wireless communication system according to the second embodiment, the cancellation signal generation unit 231 generates the cancellation signal C, by a computation equation using the plurality of transmission signals Tx11, Tx12, Tx21, and Tx22, the multiplex reception signal Rx, and the reception signal Rx3. The reception signal Rx3 is a reception signal that is not multiplexed among the plurality of reception signals Rx1, Rx2, and Rx3. Based on the cancellation signal C, the cancellation unit 224 cancels the intermodulation signals that are added to the multiplex reception signal Rx and the reception signal Rx3. In this case as well, in the wireless communication system according to the second embodiment, in comparison with the related art, the amount of computation processing for calculating the intermodulation signals (the third-order intermodulation distorations) may be suppressed from being decreased, and the circuit scale of the apparatus may be reduced.

In the first embodiment, at least one set of transmission signals among the plurality of transmission signals are multiplexed with each other, and in the second embodiment, at least one set of reception signals from the plurality of reception signals are multiplexed with each other. However, the present disclosure is not limited thereto. The first and second embodiments may be combined with each other. A third embodiment will be described as an embodiment for this case. In the third embodiment, components similar to those in the first and second embodiments will be given the same reference numerals as used in the first and second embodiments, and thus, descriptions of overlapping components and operations will be omitted.

### Third Embodiment

Problem and Solution

First, a problem of the related art and a solution to the problem in the third embodiment will be described with specific examples.

For example, it is assumed that a signal W-CDMA, and the center frequencies of the transmission signals are f11=1932.5 [MHz], f12=1937.5 [MHz], f21=1972.5 [MHz], and f22=1977.5 [MHz]. The reception frequency band of the reception signal Rx1 ranges from 1890 MHz to 1895 MHz, and the reception frequency band of the reception signal Rx2 ranges from 1895 MHz to 1900 MHz. In this case, in W-CDMA, five third-order intermodulation distortions are canceled for the reception signals Rx1 and Rx2 (see, e.g., FIG. 17). In this manner, in W-CDMA, in a case where third-order intermodulation distortions are generated from the transmission signals of the four carries, the cancellation equation generation unit 228 requires five circuits that generate the third-order intermodulation distortions, for the reception signals Rx1 and Rx2.

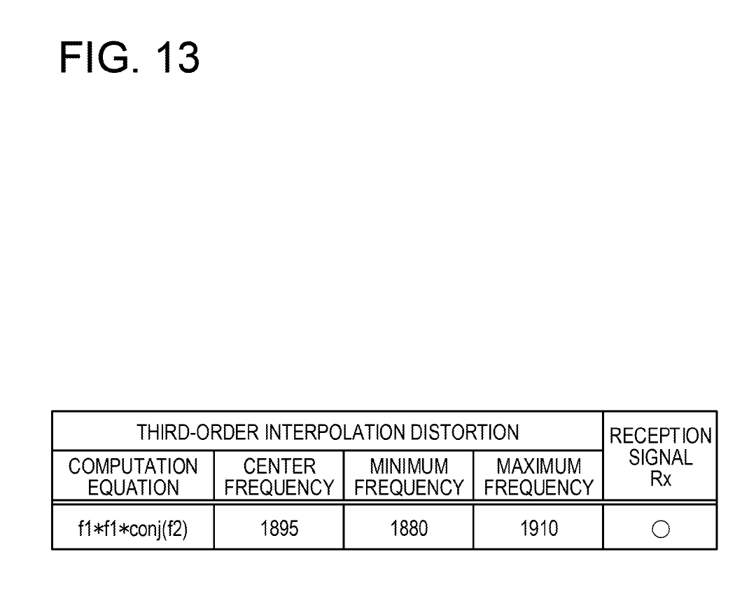

Accordingly, in order to solve the problem described above, in the third embodiment, at least one set of transmission signals among the plurality of transmission signals are multiplexed with each other, and at least one set of reception signals from the plurality of reception signals are multiplexed with each other. FIG. 13 is an explanatory diagram illustrating an example of a third-order intermodulation distortion that is a cancellation target for a reception signal in a wireless communication system according to the third embodiment.

For example, in the third embodiment, among the plurality of transmission signals Tx1 and Tx2 (transmission signals Tx11 and Tx12, in this case) that are transmitted at the different frequencies f11 and f12, respectively, are multiplexed with each other. Furthermore, in the third embodiment, among the plurality of transmission signals Tx3 and Tx4 (transmission signals Tx21 and Tx22, in this case) that are transmitted at the different frequencies f21 and f23, respectively, are multiplexed with each other. In this manner, in the third embodiment, at least one set of transmission signals are multiplexed with each other among the plurality of transmission signals. Thus, the frequencies f11 and f12 are aggregated into the frequency f1, and the frequencies f21 and f22 are aggregated into the frequency f2.

Further, in the third embodiment, among the plurality of reception signals, the reception signals Rx1 and Rx2 are multiplexed with each other. In this manner, in the third embodiment, the reception signals Rx1 and Rx3 are multiplexed with each other, and thus, the reception signals Rx1 and Rx2 may be aggregated into the reception signal Rx.

In the third embodiment, instead of simply generating a third-order intermodulation distortion from the transmission signals of the four carriers, the cancellation equation generation unit 228 multiplexes the transmission signals of the four carriers into transmission signals of two carriers and generates a third-order intermodulation distortion from the transmission signals of the two carries that result from the multiplexing. Therefore, as illustrated in FIG. 13, in the third embodiment, the third-order intermodulation, f1*f1*conj(f2), may be canceled, as one third-order intermodulation distortion, for the reception signals Rx (the multiplex reception signal). In this case, one circuit that generates a third-order intermodulation distortion for the reception signal Rx may be provided in the cancellation equation generation unit 228.

Configuration of Cancellation Apparatus 200 for Solving the Above-Described Problem

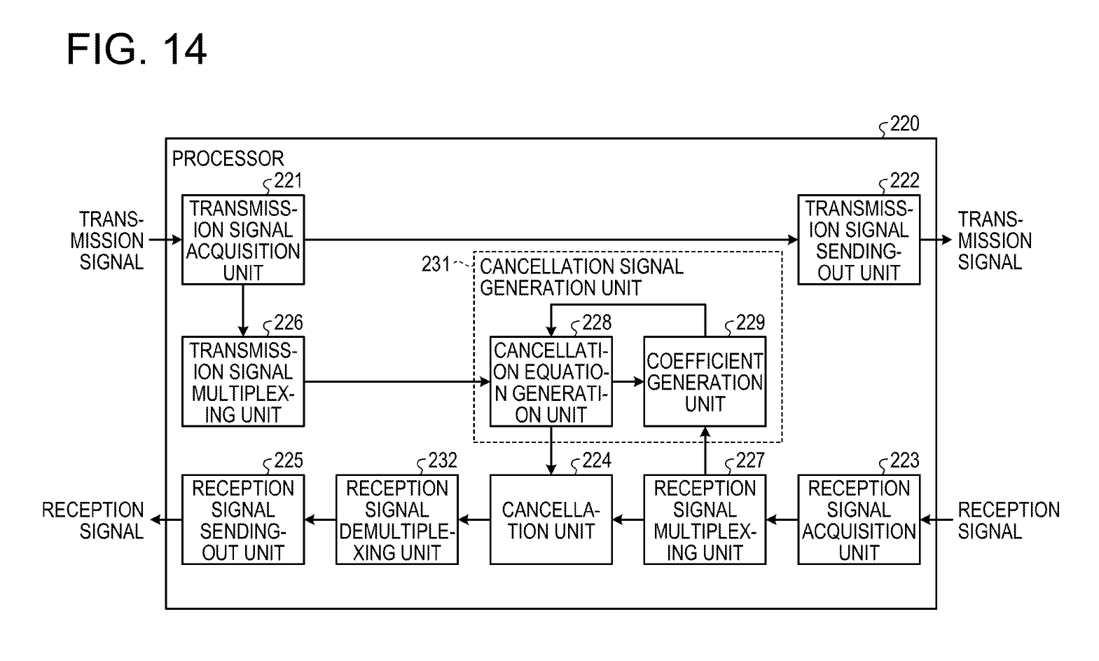

FIG. 14 is a block diagram illustrating an example of a function of the processor 220 of the cancellation apparatus 200 in the wireless communication system according to the third embodiment. The processor 220 further includes the transmission signal multiplexing unit 226 in the first embodiment, and the reception signal multiplexing unit 227 and the receive signal demultiplexing unit 232 in the second embodiment, in addition to the basic configuration in FIG. 3.

Distortion Cancellation Processing

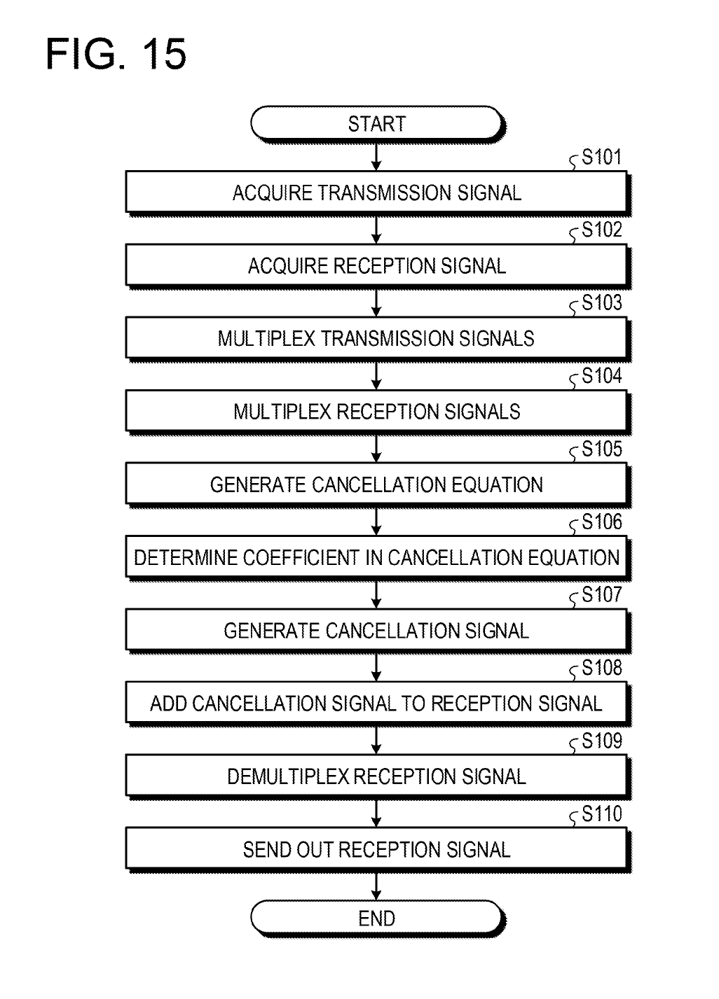

FIG. 15 is a flowchart illustrating an example of the distortion cancellation processing by the cancellation apparatus 200 in the wireless communication system according to the third embodiment.

The transmission signals Tx11, Tx12, Tx21, and Tx22 that are transmitted from the REC 100 are acquired by the transmission signal acquisition unit 221 of the processor 220 through the interface 210 (Operation S101). The transmission signals that are acquired by the transmission signal acquisition unit 221 are sent out by the transmission signal sending-out unit 222 to the REs 300a and 300b through the interface 240. Meanwhile, the reception signals Rx1 and Rx2 that are received by the REs 300a and 300b, respectively, are acquired by the reception signal acquisition unit 223 of the processor 220 through the interface 240 (Operation S102). The intermodulation signals that result from the intermodulation between the transmission signals Tx11 and Tx12 and the intermodulation between the transmission signals Tx21 and Tx22, are added to the reception signals Rx1 and Rx2, respectively, in the REs 300a and 300b.

When the transmission signals and the reception signals are acquired, among the transmission signals Tx11, Tx12, Tx21, and Tx22, the transmission signals Tx11 and Tx12 that are transmitted at the different frequencies f11 and f12, respectively, are multiplexed with each other by the transmission signal multiplexing unit 226 of the processor 220. That is, the frequencies f11 and f12 are aggregated into the frequency f1. Furthermore, among the transmission signals Tx11, Tx12, Tx21, and Tx22, the transmission signals Tx21 and Tx22 that are transmitted at the different frequencies f21 and f22, respectively, are multiplexed with each other by the transmission signal multiplexing unit 226. That is, the frequencies f21 and f22 are aggregated into the frequency f2 (Operation S103). The multiplex transmission signals at the frequencies f1 and f2, respectively, that result from the aggregation are output, as the transmission signals Tx1 and Tx2, respectively, to the cancellation signal generation unit 231.

Furthermore, the reception signals Rx1 and Rx2 are multiplexed with each other by the reception signal multiplexing unit 227 of the processor 220. That is, the reception signals Rx1 and Rx2 are aggregated into a reception signal Rx (Operation S104). The reception signal Rx (the multiplex reception signal) is output to the coefficient determination unit 229 and the cancellation unit 224.

Therefore, one third-order intermodulation is generated, by the cancellation equation generation unit 228 of the cancellation signal generation unit 231, from the transmission signals Tx1 and Tx2 at the frequencies f1 and f2, respectively, that result from the aggregation, for the reception signal Rx. Then, a cancellation equation for generating the cancellation signal C is generated, by the cancellation equation generation unit 228, from the generated one third-order intermodulation distortion, for the reception signal RX (Operation S105). That is, Equation (3) described above is generated by the cancellation equation generation unit 228. Then, the coefficient determination unit 229 determines coefficients of the cancellation equation by performing, for example, the least squares method or the correlation detection that uses the reception signal Rx (Operation S106). At this point, the coefficients S3, S5, and S7 in Equation (3) described above are determined by the coefficient determination unit 229.

In the case where the coefficients are determined, because the cancellation signal C may be generated by the cancellation equation. Thus, the cancellation signal C is generated, by the cancellation equation generation unit 228, for the reception signal Rx (Operation S107). The generated cancellation signal C is output to the cancellation unit 224. Then, the cancellation signal C is multiplexed (added) by the cancellation unit 224 with (to) the reception signal Rx (Operation S108), and thus, the intermodulation signal that is added to the reception signal Rx is canceled. The reception signal Rx from which the intermodulation signal has been canceled is demultiplexed by the reception signal demultiplexing unit 232 into the reception signals Rx1 and Rx2 (Operation S109). Thereafter, the reception signals Rx1 and Rx2 are sent out by the reception signal sending-out unit 225 to the REC 100 through the interface 210 (Operation S110).

As described above, the distortion cancellation apparatus (the cancellation apparatus 200) in the wireless communication system according to the third embodiment includes the transmission signal acquisition unit 221, the reception signal acquisition unit 223, the cancellation signal generation unit 231, and the cancellation unit 224. The cancellation apparatus 200 further includes the transmission signal multiplexing unit 226, the reception signal multiplexing unit 227, and the reception signal demultiplexing unit 232. The transmission signal acquisition unit 221 acquires the plurality of transmission signals Tx11, Tx12, Tx21, and Tx22 that are wirelessly transmitted at different frequencies. The reception signal acquisition unit 223 acquires the plurality of reception signals Rx1 and Rx2 to which the intermodulation signals (the third-order intermodulation distortions) that are generated due to the plurality of transmission signals Tx11, Tx12, Tx21, and Tx22 are added. The transmission signal multiplexing unit 226 multiplexes at least one set of transmission signals with each other among the plurality of transmission signals Tx11, Tx12, Tx21, and Tx22, and thus, generates at least one multiplex transmission signal (e.g., the multiplex transmission signal Tx1 or Tx2). The reception signal multiplexing unit 227 multiplexes at least one set of reception signals with each other from the plurality of reception signals Rx1 and Rx2, and thus, generates at least one multiplex reception signal (e.g., the multiplex reception signal Rx). The cancellation signal generation unit 231 generates the cancellation signal C that corresponds to the intermodulation signal, by a computation equation using the multiplex transmission signals Tx1 and Tx2 and the multiplex reception signal Rx. Based on the cancellation signal C, the cancellation unit 224 cancels the intermodulation signal added to the multiplex reception signal Rx. The reception signal demultiplexing unit 232 demultiplexes the multiplex reception signal Rx from which the intermodulation signal has been canceled, into the plurality of reception signals Rx1 and Rx2.

In this manner, in the wireless communication system according to the third embodiment, first, among the plurality of transmission signals Tx11, Tx12, Tx21, and Tx22, at least one set of transmission signals are multiplexed with each other, and thus, at least one multiplex transmission signal (the multiplex transmission signal Tx1 or Tx2) is generated. Furthermore, from the plurality of reception signals Rx1 and Rx2, at least one set of reception signals are multiplexes with each other, and thus, at least one multiplex reception signal (the multiplex reception signal Rx) is generated. Thereafter, the cancellation signal C is generated by the computation equation using the multiplex transmission signals Tx1 and Tx2 and the multiplex reception signal Rx. For this reason, in the wireless communication system according to the third embodiment, in comparison with the related art, the amount of computation operation processing for calculating the intermodulation signal (the third-order intermodulation distortion) may be suppressed from being increased, and the circuit scale of the apparatus may be reduced.

In each of the embodiments described above, the distortion cancellation processing is performed by the processor 220 of the cancellation apparatus 200. However, the cancellation apparatus 200 may not be necessarily installed as an independent apparatus. That is, the function of the processor 220 of the cancellation apparatus 200 may be included in, for example, the processor 110 of the REC 100. Furthermore, a processor having a function similar to that of the processor 220 may be included in the RE 300a or the RE 300b.

The distortion cancellation processing described above in each of the embodiments may be described as a computer-executable program. In this case, the program may be stored in a computer-readable storage medium and introduced into a computer. The computer-readable storage medium may include, for example, a portable storage medium such as a CD-ROM, a DVD, a USB memory, or a semiconductor memory such as a flash memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion cancellation apparatus comprising:
a memory; and
a processor coupled to the memory and the processor configured to:
acquire a plurality of transmission signals to be wirelessly transmitted at different frequencies;
acquire a first plurality of reception signals to which an intermodulation signal generated due to the plurality of transmission signals wirelessly transmitted is added;
multiplex at least one set of transmission signals among the plurality of transmission signals to be wirelessly transmitted so as to generate at least one multiplexed transmission signal;
generate a cancellation signal for canceling the intermodulation signal, based on the at least one multiplexed transmission signal and the first plurality of reception signals; and
cancel the intermodulation signal added to the first plurality of reception signals, based on the cancellation signal.

2. The distortion cancellation apparatus according to claim 1,
wherein the processor is configured to generate the cancellation signal, based on the at least one multiplexed transmission signal, a transmission signal not multiplexed among the plurality of transmission signals to be wirelessly transmitted, and the first plurality of reception signals.

3. The distortion cancellation apparatus according to claim 1,
wherein the processor is further configured to multiplex at least one set of reception signals among the first plurality of reception signals, so as to generate at least one multiplexed reception signal,
wherein the processor is configured to generate the cancellation signal, based on the at least one multiplexed transmission signal and the at least one multiplexed reception signal, and cancel the intermodulation signal added to the at least one multiplexed reception signal, based on the cancellation signal, and
wherein the processor is further configured to demultiplex the at least one multiplexed reception signal from which the intermodulation signal has been canceled, into a second plurality of reception signals.

4. A distortion cancellation apparatus comprising:
a memory; and
a processor coupled to the memory and the processor configured to:
acquire a plurality of transmission signals to be wirelessly transmitted at different frequencies;
acquire a first plurality of reception signals to which an intermodulation signal generated due to the plurality of transmission signals wirelessly transmitted is added;
multiplex at least one set of reception signals among the first plurality of reception signals so as to generate at least one multiplexed reception signal;
generate a cancellation signal for canceling the intermodulation signal, based on the plurality of transmission signals to be wirelessly transmitted and the at least one multiplexed reception signal;
cancel the intermodulation signal added to the at least one multiplexed reception signal, based on the cancellation signal; and
demultiplex the at least one multiplexed reception signal from which the intermodulation signal has been canceled, into a second plurality of reception signals.

5. The distortion cancellation apparatus according to claim 4,
wherein the processor is configured to
generate the cancellation signal, based on the plurality of transmission signals to be wirelessly transmitted, the at least one multiplexed reception signal, and a reception signal not multiplexed among the first plurality of reception signals, and
cancel the intermodulation signal added to the at least one multiplexed reception signal and the reception signal not multiplexed, based on the cancellation signal.

6. A distortion cancellation method comprising:
acquiring a plurality of transmission signals to be wirelessly transmitted at different frequencies;
acquiring a plurality of reception signal to which an intermodulation signal generated due to the plurality of transmission signal wirelessly transmitted is added;
multiplexing at least one set of transmission signals among the plurality of transmission signals to be wirelessly transmitted so as to generate at least one multiplexed transmission signal;
generating a cancellation signal for canceling the intermodulation signal, based on the at least one multiplexed transmission signal and the plurality of reception signals; and
cancelling the intermodulation signal added to the plurality of reception signals, based on the cancellation signal, by a processor.
